(19) United States
(12) Patent Application Publication
(10) Pub. No.: US 2005/0057511 A1
(43) Pub. Date: Mar. 17, 2005

(54) [BALL-ACTUATED OPTICAL MOUSE]

(75) Inventor: Yung-Hui Wang, TAIPEI (TW)

Correspondence Address: PATEN WIRELESS TECHNOLOGY INC., 2F-4, NO. 148, SEC. 4, CHUNG HSIAO EAST ROAD, TAIPEI, TW

(73) Assignee: PATEN WIRELESS TECHNOLOGY INC., NEI-HU DISTRICT, TAIPEI CITY (TW)

(21) Appl. No.: 10/710,694

(22) Filed: Jul. 29, 2004

(30) Foreign Application Priority Data
Aug. 20, 2003 (TW) 092215133

(51) Int. Cl. G09G 5/08

(52) U.S. Cl. 345/166

(57) ABSTRACT

A ball-actuated optical mouse includes a housing holding a ball for rotation on a flat surface upon movement of the housing by the user, an image sensor for detecting the direction and amount of movement of the ball, a light source controlled by a sensor switch to emit light onto the ball upon rotation of the ball in the housing, and a refractor for refracting light from the light source onto the ball and focusing reflected light from the ball onto the image sensor through a circular arc surface thereof.

### CROSS REFERENCE TO RELATED APPLICATIONS

This application claims the priority benefit of Taiwan patent application number 092215133 filed on Aug. 20, 2003.

### BACKGROUND OF INVENTION

1. Field of the Invention

The present invention relates to an optical mouse for controlling the positioning of a cursor on a display screen and more particularly, to ball-actuated optical mouse, which is free from the effect of mirror surface, outside reflecting light, or color and, which is operative on any flat surface.

2. Description of the Related Art

A pointer is one of the standard peripheral apparatus of a computer system. More particularly to a windows operating system user, a mouse is the requisite pointer. Conventionally, a mouse is a mechanical design that carries a ball. The ball has a part protruding over the bottom wall of the housing of the mouse in contact with an external surface (for example, the surface of the top of a desk). When moving the mouse on a flat surface, the ball is forced to rotate and to touch X-axis and Y-axis detecting mechanisms of a detector. The detector converts the moving direction and amount of the ball into a corresponding electric signal and then inputs the signal into the computer. This design of mechanical mouse is not satisfactory in function because of low cursor control speed. Further, this design of mechanical mouse does not provide a power safe mode. In order to eliminate this problem, a semi-optical mouse was developed. A semi-optical mouse comprises two rollers arranged at right angles and respectively maintained in friction contact with a ball, two sensor units respectively provided at the rollers, and an IC. Each sensor unit comprises a wheel fastened to one roller, a light emitter disposed at one side of the wheel, and a light receiver disposed at the other side of the wheel. The wheel has a plurality of peripheral notches equiangularly spaced around the periphery. During movement of the ball to rotate the rollers, the wheel at each roller is rotated to interrupt light from the respective light emitter, and the respective light receiver picks up the light signal from the wheel and sends the signal to the IC, enabling the IC to calculate the direction and amount of movement of the ball. This design of semi-optical mouse is not practical for use with high-grade software, for example, AutoCAD, PRO-E for the disadvantage of low positioning precision. Therefore, full optical mice are developed. A full optical mice uses a refractor to project light from the light source onto the contact surface, and a sensor to pick up reflected light from the contact surface and to convert the light signal into an electric signal indicative of the direction and amount of movement of the optical mouse on the contact surface. The scan frequency per second of a full optical mouse can be as much as 1000 times up. Nowadays, optical mice are commonly used with personal computers. However, conventional optical mice cannot be moved on a reflecting surface or a glass surface. If an optical mouse is used on a color surface, a gap of movement or vibration of the cursor on the screen may occur. Further, conventional optical mice commonly have a power save mode. However, because this power save mode requires a circuit to detect a re-triggering signal, the power saving condition is limited to a certain extent.

These conventional optical mice are designed for use with desktop personal computers, not satisfactory for use with a notebook computer.

Therefore, it is desirable to provide an optical mouse that eliminates the aforesaid drawbacks.

### SUMMARY OF INVENTION

The present invention has been accomplished under the circumstances in view. It is therefore the main object of the present invention to provide a ball-actuated optical mouse, which is practical for use on any flat surface, and free from the influence of mirror surface, outside reflecting light, or color. It is another object of the present invention to provide a ball-actuated optical mouse, which shortens the radiating distance of the light source, thereby improving the sensitivity and resolution to achieve a high performance. It is still anther object of the present invention to provide a ball-actuated optical mouse, which automatically turns off the light source to save power consumption when not operated.

To achieve these and other objects of the present invention, the ball-actuated optical mouse comprises a housing, the housing comprising a base, the base comprising an upright open chamber, a top cover covered on a top side of the base, the top cover comprising a plurality of operation buttons, and an annular bottom cap covered on a bottom side of the base corresponding to a bottom side of the upright open chamber; a ball and roller unit mounted in the base inside the housing, the ball and roller unit comprising a ball mounted inside the upright open chamber and partially peripherally protruding over the annular bottom cap for friction contact with a flat surface; and an optical unit mounted inside the housing and adapted to detect the direction and amount of movement of the ball in the upright open chamber, the optical unit comprising a circuit board supported on the base, a light source controlled by the circuit board to emit light toward the ball, an image sensor adapted to pick up reflected light from the ball and to convert received reflected light into an electric signal indicative of direction and amount of movement of the ball in the upright open chamber, and a refractor adapted to refract light from the light source onto the ball and to focus reflected light from the ball onto the image sensor.

### BRIEF DESCRIPTION OF DRAWINGS

FIG. 1 is an elevational view of an optical mouse according to the present invention.

FIG. 2 is an exploded view of the optical mouse according to the present invention.

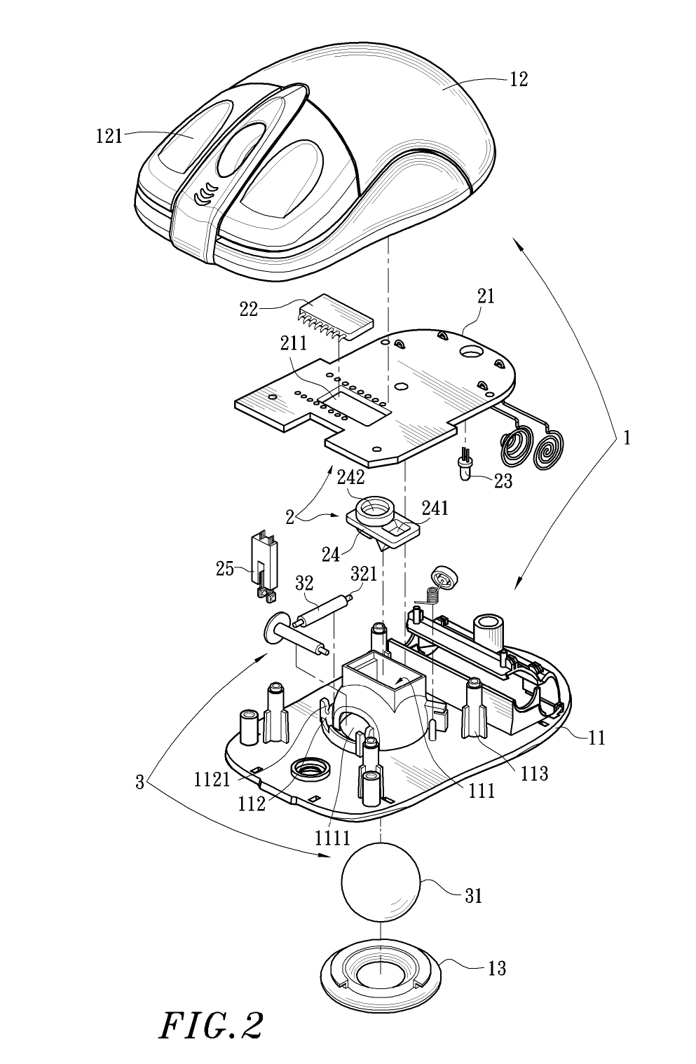

FIG. 3 is a side view in section in an enlarged scale of a part of the optical mouse shown in FIG. 1.

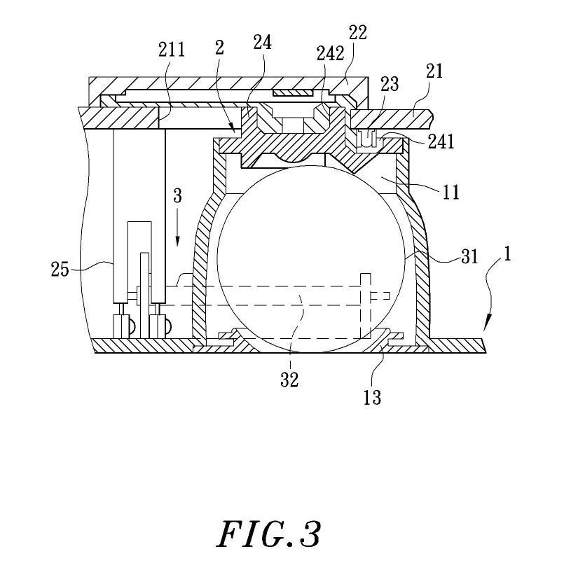

FIG. 4 is similar to FIG. 3 but showing the optical mouse in operation.

### DETAILED DESCRIPTION

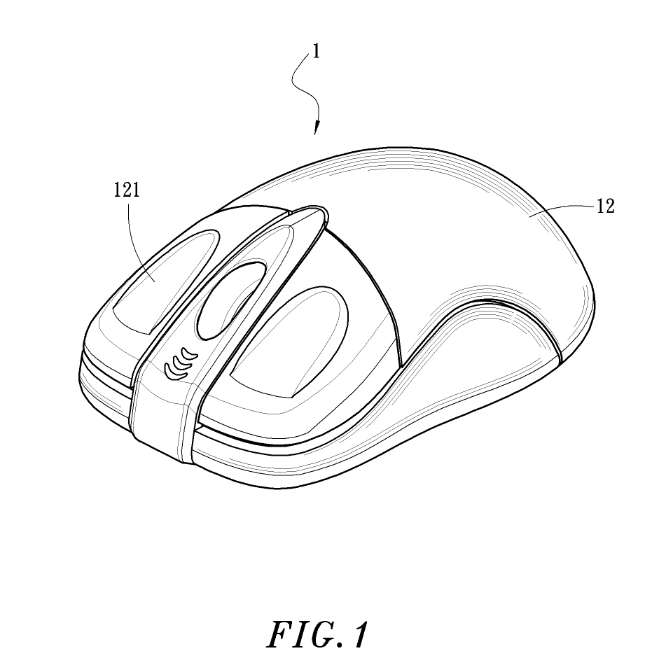

Referring to FIGS. 1˜3, a ball-actuated optical mouse is shown comprised of a housing 1, an optical unit 2, and a ball and roller unit 3.

The housing 1 is comprised of a base 11, a top cover 12, and an annular bottom cap 13. The base 11 comprises an upright open chamber 111, which has a plurality of peripheral openings 1111 (for example two openings arranged at right angles), a plurality of locating plates 112 symmetrically disposed at two sides of each of the peripheral openings 1111, and a plurality of upright supports 113. Each locating plate 112 has a top coupling hole 1121. The top cover 12 is provided with a plurality of operation buttons 121.

The optical unit 2 is comprised of a circuit board 21, an image sensor 22, a light source 23, a refractor 24, and a sensor switch 25. The circuit board 21 has an opening 211. The refractor 24 has a recessed receiving chamber 241 and a circular arc surface 242.

The ball and roller unit 3 is comprised of a ball 31 and a plurality of rollers 32. Each roller 32 has two ends respectively terminating in a round pin 321.

During installation, the ball 31 is inserted into the upright open chamber 111 of the base 11 from the bottom side of the housing 1, and then the annular bottom cap 13 is fastened to the bottom side of the base 11 to hold the ball 31 in the upright open chamber 111, and then the round pins 321 of the rollers 32 are respectively pivotally coupled to the top coupling holes 1121 of the locating plates 112, and then the refractor 24 is capped on the top side of the upright open chamber 111, and then the image sensor 22 is installed in the circuit board 21 above the opening 211, and then the light source 23 and the sensor switch 25 are installed in the circuit board 21, and then the circuit board 21 is fixedly fastened to the upright supports 113 of the base 11 to have the light source 23 be received in the recessed receiving space 241 of the refractor 24, and at final the top cover 12 is closed on the base 11. When assembled, the ball 31 partially protrudes over the peripheral openings 1111 of the upright open chamber 111 and the inner diameter of the annular bottom cap 13, and the rollers 32 are peripherally kept in friction contact with the periphery of the ball 31. The sensor switch 25 is adapted to detect the operation status of the rollers 32.

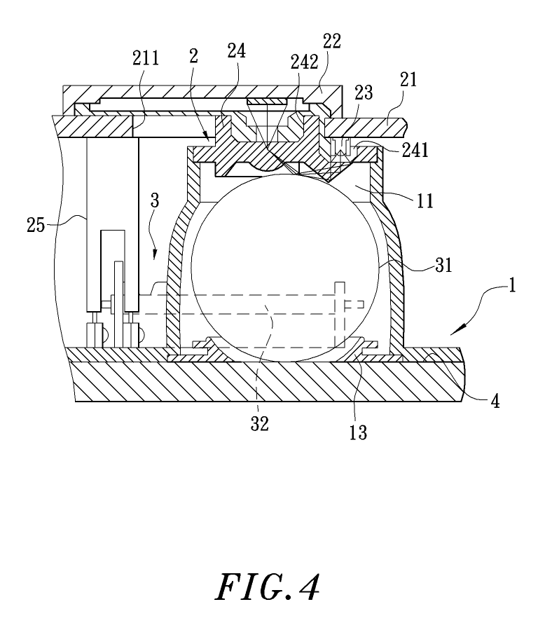

Referring to FIG. 4, when in use, the housing 1 is placed on a flat contact surface 4, and the refractor 24 refracts light from the light source 23 onto the surface of the ball 31, reflects the light onto the circular arc surface 242 of the refractor 24, enabling the circular arc surface 242 to focus the reflected light onto the image sensor 22 through the opening 211 of the circuit board 21. Upon receipt of the reflected light, the image sensor 22 converts the light signal into a corresponding electric signal indicative of the direction of amount of movement of the ball 31.

If the rollers 32 do no work for a predetermined length of time, the sensor switch 25 detects the status and then drives the circuit board 21 to cut off power supply from the light source 23, thereby entering the power save mode. When rotating the rollers 32 again, the sensor switch 25 immediately drives the circuit board 21 to turn on the light source 23.

As indicated above, the ball-actuated optical mouse has the following features.

1. The invention uses the optical unit 2 to detect the direction and amount of movement of the ball 31. Therefore, the optical mouse can be moved on any flat surface, and is free from the interference of mirror surface, outside reflecting light, or color.

2. The short distance between the ball 31 and image sensor 22 shortens the radiating distance of the light source 23, thereby improving the sensitivity and resolution of the optical mouse to achieve a high performance.

3. The sensor switch 25 detects the operation status of the rollers 32, controlling the circuit board 21 to automatically turn on/off the light source 23 subject to the operation status of the optical mouse, thereby saving power supply.

A prototype of ball-actuated optical mouse multipurpose has been constructed with the features of FIGS. 1˜4. The ball-actuated optical mouse functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A ball-actuated optical mouse comprising:
a housing, said housing comprising a base, said base comprising an upright open chamber, a top cover covered on a top side of said base, said top cover comprising a plurality of operation buttons, and an annular bottom cap covered on a bottom side of said base corresponding to a bottom side of said upright open chamber;
a ball and roller unit mounted in said base inside said housing, said ball and roller unit comprising a ball mounted inside said upright open chamber and partially peripherally protruding over said annular bottom cap for friction contact with a flat surface; and
an optical unit mounted inside said housing and adapted to detect the direction and amount of movement of said ball in said upright open chamber, said optical unit comprising a circuit board supported on said base, a light source controlled by said circuit board to emit light toward said ball, an image sensor adapted to pick up reflected light from said ball and to convert received reflected light into an electric signal indicative of direction and amount of movement of said ball in said upright open chamber, and a refractor adapted to refract light from said light source onto said ball and to focus reflected light from said ball onto said image sensor.

2. The ball-actuated optical mouse as claimed in claim 1, wherein said base comprises a plurality of upright supports that support said circuit board above said upright open chamber.

3. The ball-actuated optical mouse as claimed in claim 1, wherein said circuit board has an opening; said image sensor is installed in said circuit board above said opening.

4. The ball-actuated optical mouse as claimed in claim 1, wherein said ball and roller unit further comprises a plurality of rollers pivotally mounted in said base inside said housing and respectively peripherally maintained in friction contact with said ball.

5. The ball-actuated optical mouse as claimed in claim 4, wherein said optical unit further comprises a sensor switch electrically connected to said circuit board and adapted to detect the operation of said rollers and to drive said circuit board to control power supply to said light source subject to the operation status of said rollers.
